(19) United States
(12) Patent Application Publication
(10) Pub. No.: US 2015/0126075 A1
(43) Pub. Date: May 7, 2015

(54) POWER PLUG AND POWER RECEPTACLE

(71) Applicant: Bellwether Electronic Corp., Taoyuan County (TW)

(72) Inventors: Kuan-Wu CHEN, TAOYUAN COUNTY (TW); Hsing-Yu LEE, TAOYUAN COUNTY (TW)

(21) Appl. No.: 14/444,484

(22) Filed: Jul. 28, 2014

(30) Foreign Application Priority Data
Nov. 5, 2013 (TW) 102220620

(51) Int. Cl. H01R 13/642

(52) U.S. Cl. CPC H01R 13/642
USPC 439/678

(57) ABSTRACT

A power plug including an insulation main body is provided. A first pillar and a second pillar arranged at the insulation main body. Only a first channel for inserting a first plug terminal is defined on the first pillar and multiple second channels for inserting second plug terminals are defined on the second pillar. A power receptacle including an insulation base is provided. A first slot and a second slot respectively corresponding to the first pillar and the second pillar are defined at the insulation base. Only a first receptacle terminal is inserted in the first slot. Multiple second receptacle terminals arranged at interval and parallel with each other are inserted in the second slot. The first receptacle terminal and the second receptacle terminals are arranged in a row. The power plug and the power receptacle are thereby limited to correctly couple.

### BACKGROUND

The present disclosure is related to power connectors, particularly a power plug including fool-proofing means and a corresponding power receptacle.

### DESCRIPTION OF RELATED ART

Since no fool-proofing means is provided for known power connectors, a male power connector can be plugged into a female power connector along a correct direction or a counter direction. Furthermore, the male power connector can also be plugged into the female power connector as the male power connector is deflected 90 degrees, and the connectors might therefore be broken. Software or hardware damages resulted from miss operation might occur if the connectors are not allowed to be coupled along the counter direction or other directions and no fool-proofing means is provided for the connectors.

In views of this, in order to solve the above disadvantage, the present inventor studied related technology and provided a reasonable and effective solution in the present disclosure.

### SUMMARY

A main purpose of the present disclosure is providing a power plug including fool-proofing means and a corresponding power receptacle, the fool-proofing means can work in any incorrect plugging direction, and the thereby ensuring a correct connection to prevent from software or hardware damages.

In order to achieve above purpose, a power plug including an insulation main body, a first plug terminal and multiple second plug terminals is provided in the present disclosure. The insulation main body having a main body top surface, a first pillar and a second pillar are protruded from the main body top surface, the first pillar and the second pillar are arranged at interval, only a first channel is defined on the first pillar along a longitudinal direction of the first pillar, multiple second channels are defined on the second pillar along a longitudinal direction of the first pillar, and the first channel and the second channels are arranged in a row. The first plug terminal is inserted in the first channel, and each second plug terminal is inserted in one of the second channel.

Multiple main body lateral surfaces surrounding the main body top surface are preferably formed on the insulation main body, and a hook is provided on one of the main body lateral surfaces.

A first external chamfer is preferably defined at a corner of the first pillar.

A second external chamfer is preferably defined at a corner of the second pillar.

In order to achieve above purpose, a power receptacle for coupling with above power plug is further provided in the present disclosure, and the power receptacle is included of an insulation base, a first receptacle terminal and multiple second receptacle terminals. The insulation base having a base top surface, a first slot for sheathing the first pillar and a second slot for sheathing the second pillar are defined on the base top surface, and the first slot and the second slot are arranged at interval. The first receptacle terminal for coupling with the first plug terminal, and only a first terminal is inserted in the first slot. The second receptacle terminals are respectively inserted in the second slots for coupling with the second plug terminals, and the second receptacle terminals are arranged at interval and parallel with each other.

Multiple base lateral surfaces surrounding the base top surface are preferably formed on the insulation base, and a latch is provided on the base lateral surfaces.

Each first receptacle terminal is preferably extended to protrude a bottom of the corresponding first slot.

Each second receptacle terminal is preferably extended to protrude a bottom of the corresponding second slot.

A first internal chamfer is preferably arranged at a corner of the first slot.

A second internal chamfer is preferably arranged at a corner of the second slot.

The second pillar of the power plug is not able to plug into the first slot of the power receptacle. By mixed arrangement of the first pillar and the second pillar, the power plug can plug into the power receptacle only along a correct coupling direction.

### BRIEF DESCRIPTION OF DRAWING

FIG. 1 is a schematic diagram showing the power plug and the power receptacle of the first embodiment of the present disclosure.

FIG. 2 is a schematic diagram showing the power plug of the first embodiment.

FIG. 3 is a schematic diagram showing the power receptacle of the first embodiment.

FIG. 4 is a schematic diagram showing the power plug coupled with the power receptacle.

FIG. 5 is another schematic diagram showing the power plug coupled with the power receptacle.

FIG. 6. is a schematic diagram showing the power plug incorrectly coupled with the power receptacle.

FIG. 7 is a schematic diagram showing the power plug of the second embodiment.

FIG. 8 is a schematic diagram showing the power receptacle of the second embodiment.

FIG. 9 is a schematic diagram showing the power plug of the third embodiment.

FIG. 10 is a schematic diagram showing the power receptacle of the third embodiment.

FIG. 11 is a schematic diagram showing the power plug of the fourth embodiment.

FIG. 12 is a schematic diagram showing the power receptacle of the fourth embodiment.

FIG. 13 is a schematic diagram showing the power plug of the fifth embodiment.

FIG. 14 is a schematic diagram showing the power receptacle of the fifth embodiment.

### DETAILED DESCRIPTION OF EMBODIMENT

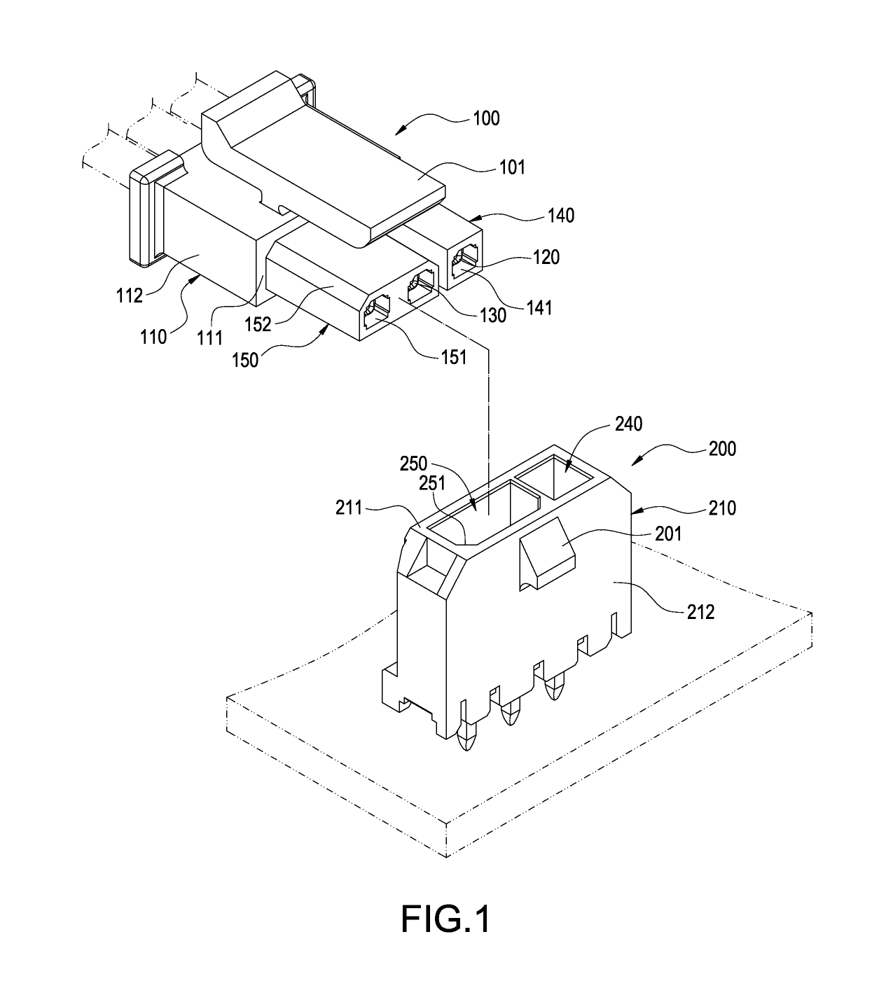

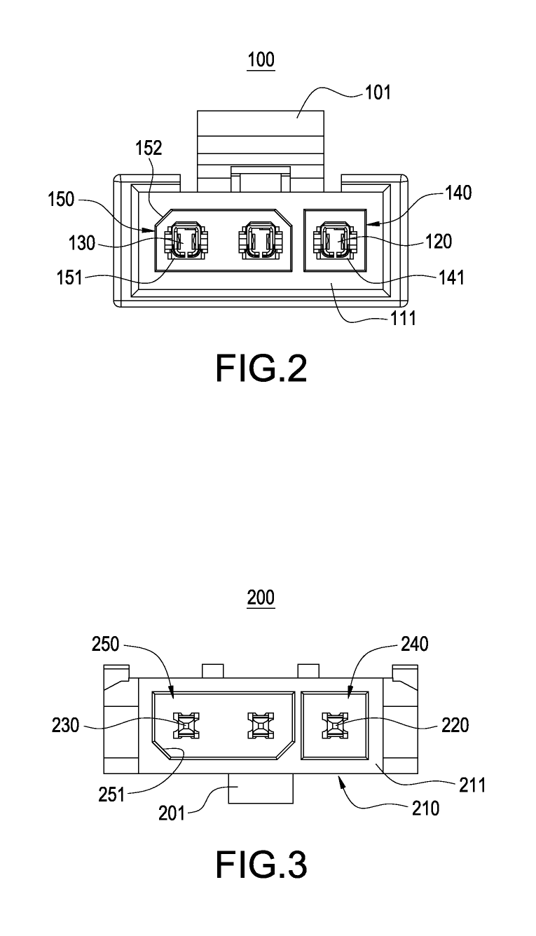

Please refer to FIG. 1-4. A power plug 100 and a corresponding power receptacle 200 are provided in the first embodiment of the present disclosure. In the present embodiment, the power plug 100 is included of an insulation main body 110, a first plug terminal 120 and two second plug terminal 130.

The insulation main body 110 is preferable a hexahedral and made of plastic. The insulation main body 110 has a main body top surface 111 and four main body lateral surfaces 112 surrounding the main body top surface 111, and each main body lateral surface 112 is preferably perpendicular connected with the main body top surface 111. A first pillar 140 and a second pillar 150 are respectively protrude from the main body top surface 111, a hook 101 is provided on one of the main body lateral surface 112, and the hook 101 is preferably extended over the main body top surface 111. The first pillar 140 and the second pillar 150 are arranged at interval. The first pillar 140 is of a rectangular columnar shape, and only a first channel 141 is defined on the first pillar 140 along a longitudinal direction of the first pillar 140. The second pillar 150 is of a rectangular columnar shape, at least a width of the second pillar 150 is larger than the maximum width of the first pillar 140, and multiple second channels 151 are defined on the second pillar 150 along a longitudinal direction of the second pillar 150. In the present embodiment, the first channel 141 and the second channels 151 are arranged in a column matrix and parallel with each other.

The first plug terminal 120 is made of metal and preferably of a tubular shape. The first plug terminal 120 is inserted in the first channel 141. Each second plug terminal 130 is made of metal and preferably of a tubular shape. Each second plug terminal 130 is inserted in the corresponding second channel 151.

The power receptacle 200 is used for coupling with the power plug 100. The power receptacle 200 is included of an insulation base 210, a first receptacle terminal 220 and two second receptacle terminal 230. The insulation base 210 is preferable a hexahedral and made of plastic. The insulation base 210 has a base top surface 211 and four base lateral surfaces 212 surrounding the main body top surface 111, and each base lateral surface 212 is preferably perpendicular connected with the base top surface 211. A first slot 240 for coupling with the first pillar 140 and a second slot 250 for coupling with the second pillar 150 are defined on the base top surface 211, and a latch 201 for snapping the hook 101 is provided on one of the base lateral surface 212. The first slot 240 and the slot 250 are arranged at interval, and the first slot 240 and the slot 250 are arranged respectively corresponded to the first pillar 140 and the second pillar 140. Two second internal chamfers 251 are respectively formed at two corners in the second slot 250, and each second internal chamfer 251 is arranged corresponding to one of the first external chamfer 152.

The first receptacle terminal 220 is made of metal, the first receptacle terminal 220 is preferably of a pillar shape, and an outer contour of the first receptacle terminal 220 is corresponded to an inner contour of the first plug terminal 120. The first receptacle terminal 220 is inserted in the first slot 240 and used for coupling with the first plug terminal 120.

Each second receptacle terminal 230 is made of metal, and the second receptacle terminal 230 is preferably of a pillar shape and has the same structure as the first receptacle terminal 220. Each second receptacle terminal 230 is used for coupling with the corresponding second plug terminal 10, the second receptacle terminals 230 are respectively inserted in the corresponding second slot 250, and the second receptacle terminals 230 are arranged at interval in a row and parallel with each other. The first receptacle terminal 220 and the second receptacle terminal 230 are arranged in a row. Each first receptacle terminal 220 is extended through a bottom of the corresponding first slot 240, and each second receptacle terminal 230 is extended through a bottom of the corresponding second slot 250.

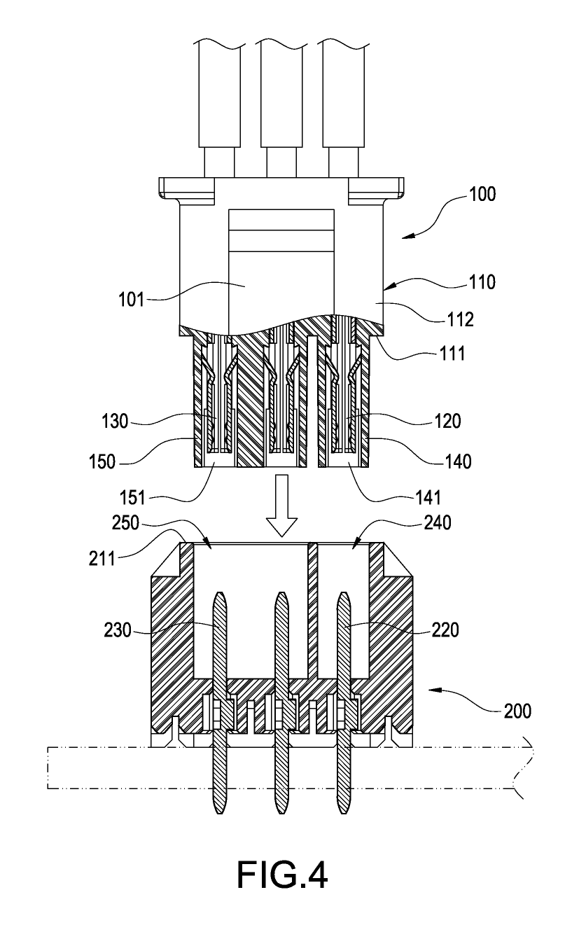

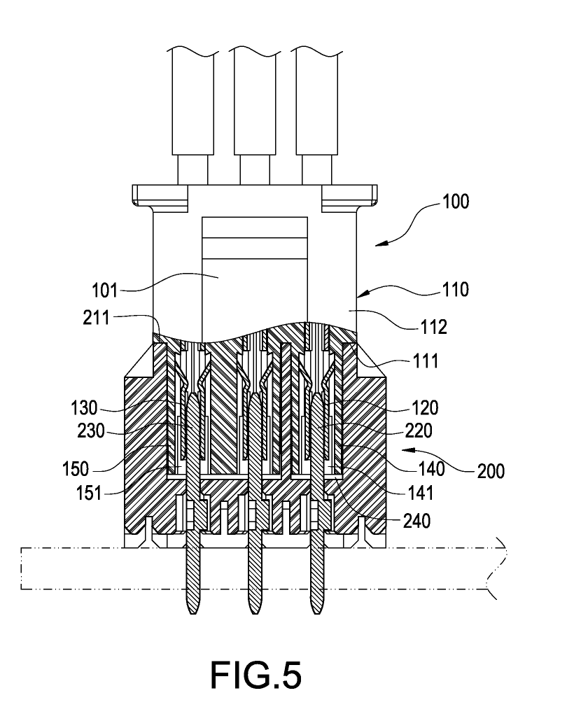

Please refer to FIGS. 4 and 5. The first pillar 140 is inserted into the first slot 240 while the power plug 100 is correctly coupled with the power receptacle 200, and the first plug terminal 120 in the first pillar 140 is thereby electrically connected with the first receptacle terminal 220. The second pillar 150 is meanwhile inserted into the second slot 250, and each second plug terminal 130 in the second pillar 150 is thereby respectively electrically connected with the corresponding second receptacle terminal 230. The hook 101 of the power plug 100 is snap-locked with latch 201 of the power receptacle 200, and the both are thereby firmly connected with each other.

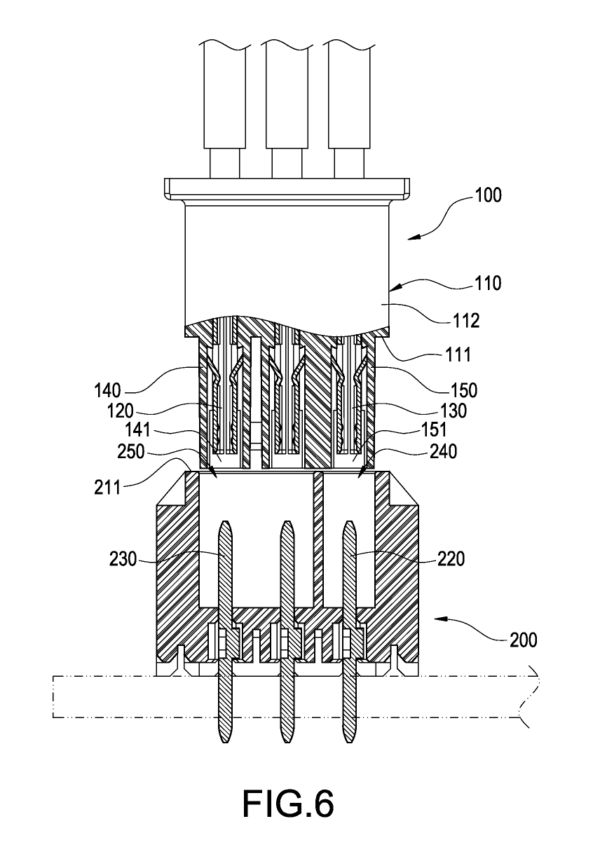

Please refer to FIG. 6. The second pillar 150 cannot be inserted into the first slot 240 while the power plug 100 is incorrectly coupled with the power receptacle 200. The power plug 100 and the power receptacle 200 are limited by the mixed arrangement of the first pillar 140 and the second pillar 150 and therefore able to be couple with each other merely along a correct direction.

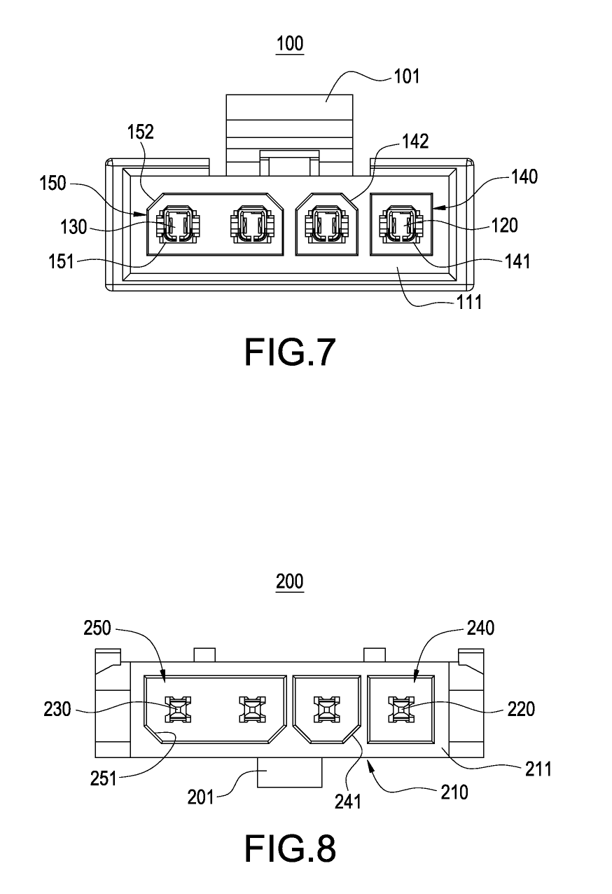

Please refer to FIGS. 7 and 8. A power plug 100 and a corresponding power receptacle 200 are provided in the second embodiment of the present disclosure. In the present embodiment, the power plug 100 and the power receptacle 200 are similar to those described in the first embodiment, therefore the descriptions for the same/similar elements are omitted here for brevity.

In the present embodiment, two first pillars 140 and a second pillar 150 are extended from the insulation main body 110 of the power plug 100, a first plug terminal 120 is contained in each first pillar 140, and two second channels 151 are defined on the second pillar 150 to contain two second plug terminals 130. The first plug terminals 120 and the second plug terminals 130 are arranged in a row. The power receptacle 200 has a structure corresponding to the power plug 100. Two first slots 240 and a second slot 250 are defined on the insulation base 210, a first receptacle terminal 220 is contained in each first slot 240, and two second receptacle terminals 230 are contained in the second slot 250.

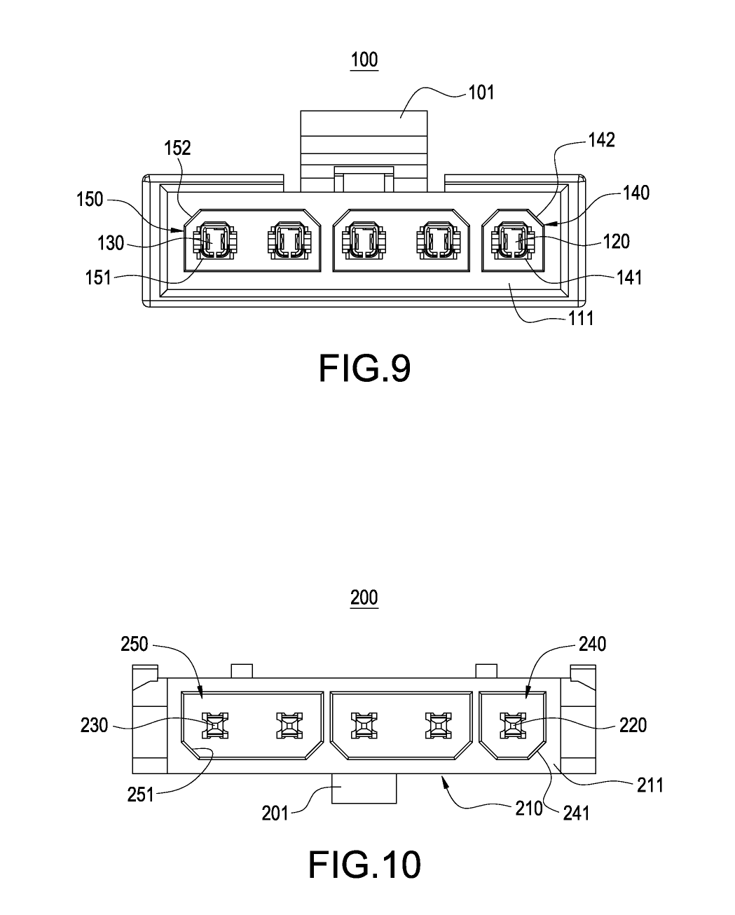

Please refer to FIGS. 9 and 10. A power plug 100 and a corresponding power receptacle 200 are provided in the third embodiment of the present disclosure. In the present embodiment, the power plug 100 and the power receptacle 200 are similar to those described in the first embodiment, therefore the descriptions for the same/similar elements are omitted here for brevity.

In the present embodiment, a first pillar 140 and two second pillars 150 are extended from the insulation main body 110 of the power plug 100, a first plug terminal 120 is contained in the first pillar 140, and two second channels 151 are defined on each second pillar 150 to respectively contain two second plug terminals 130. The first plug terminals 120 and the second plug terminals 130 are arranged in a row. The power receptacle 200 has a structure corresponding to the power plug 100. A first slot 240 and two second slots 250 are defined on the insulation base 210, a first receptacle terminal 220 is contained in the first slot 240, and two second receptacle terminals 230 are contained in each second slot 250. The first receptacle terminal 220 and the second receptacle terminals 230 are arranged in a row according to the first plug terminals 120 and the second plug terminals 130.

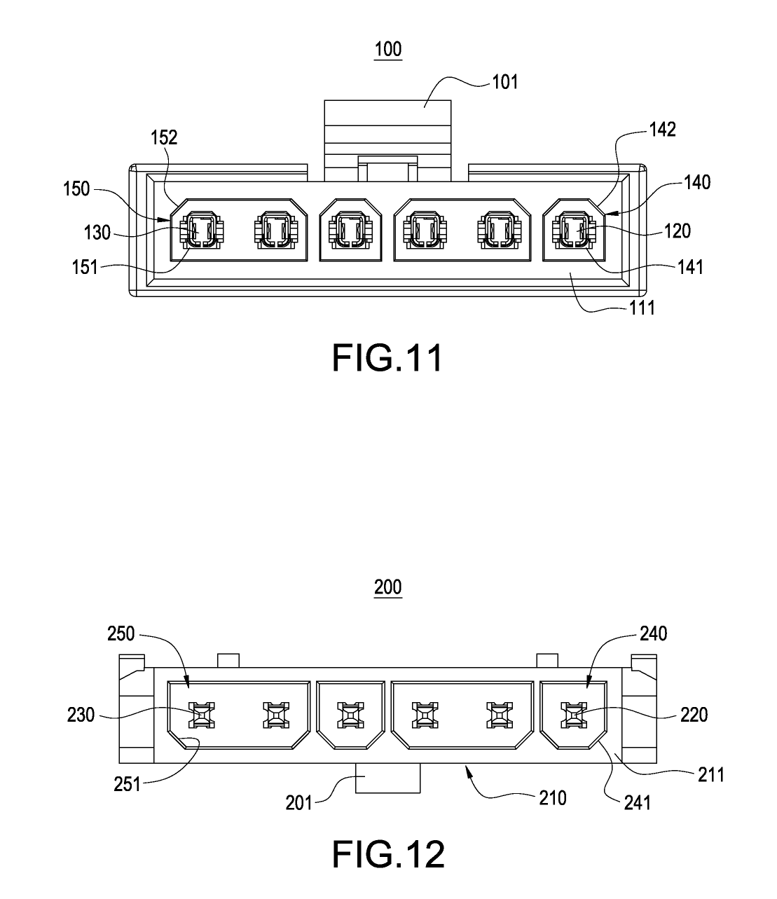

Please refer to FIGS. 11 and 12. A power plug 100 and a corresponding power receptacle 200 are provided in the fourth embodiment of the present disclosure. In the present embodiment, the power plug 100 and the power receptacle 200 are similar to those described in the first embodiment, therefore the descriptions for the same/similar elements are omitted here for brevity.

In the present embodiment, two first pillars 140 and two second pillars 150 are extended from the insulation main body 110 of the power plug 100, a first plug terminal 120 is contained in each first pillar 140, and two second channels 151 are defined on each second pillar 150 to respectively contain two second plug terminals 130. The first pillars 140 and the second pillars 150 are alternately arranged in a row, and the first plug terminals 120 and the second plug terminals 130 are arranged in a row. The power receptacle 200 has a structure corresponding to the power plug 100. Two first slots 240 and two second slots 250 are defined on the insulation base 210, a first receptacle terminal 220 is contained in each first slot 240, and two second receptacle terminals 230 are contained in each second slot 250. The first receptacle terminal 220 and the second receptacle terminals 230 are arranged in a row according to the first plug terminals 120 and the second plug terminals 130.

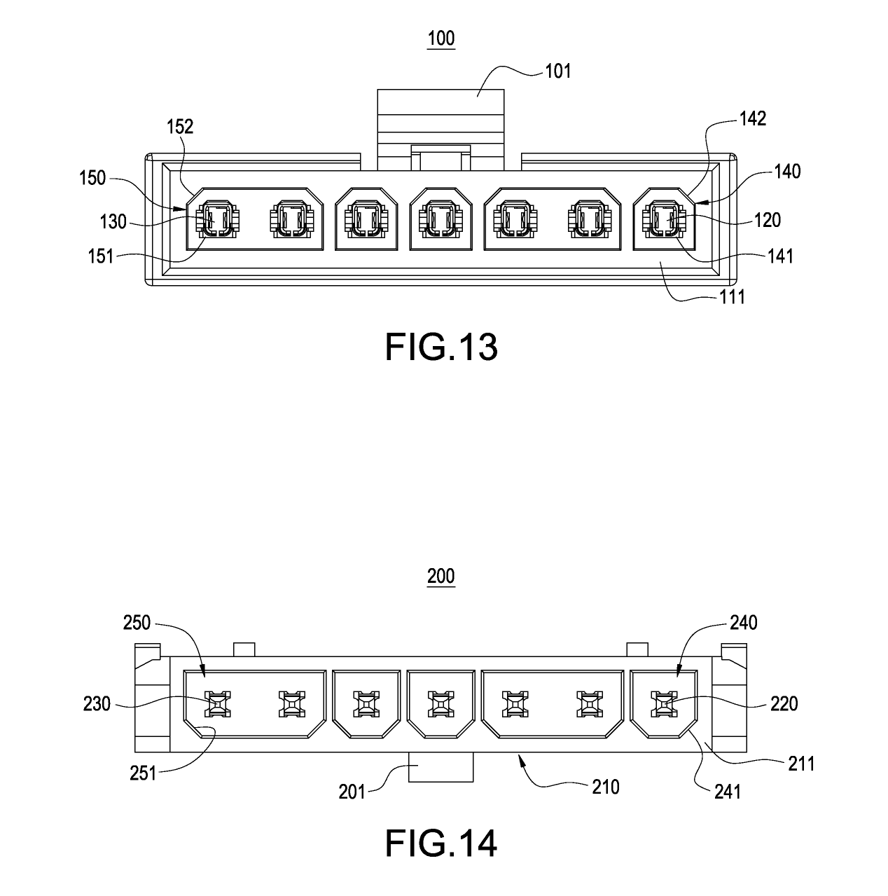

Please refer to FIGS. 13 and 14. A power plug 100 and a corresponding power receptacle 200 are provided in the fifth embodiment of the present disclosure. In the present embodiment, the power plug 100 and the power receptacle 200 are similar to those described in the first embodiment, therefore the descriptions for the same/similar elements are omitted here for brevity.

In the present embodiment, three first pillars 140 and two second pillars 150 are extended from the insulation main body 110 of the power plug 100, a first plug terminal 120 is contained in each first pillar 140, two first external chamfers 142 are preferably formed at two corners of each first pillar 140, and two second channels 151 are defined on each second pillar 150 to respectively contain two second plug terminals 130. The first pillars 140 and the second pillars 150 are alternately arranged in a row, and the first plug terminals 120 and the second plug terminals 130 are arranged in a row. The power receptacle 200 has a structure corresponding to the power plug 100. Three first slots 240 and two second slots 250 are defined on the insulation base 210, a first receptacle terminal 220 is contained in each first slot 240, and two second receptacle terminals 230 are contained in each second slot 250. The first receptacle terminal 220 and the second receptacle terminals 230 are arranged in a row according to the first plug terminals 120 and the second plug terminals 130. Two first internal chamfers 241 are formed at two corners in each first slot 240, and each first internal chamfer 241 is arranged corresponding to one of the first external chamfers 142.

The power plug 100 and the power receptacle 200 of the present disclosure are limited to couple along a correct direction by an arrangement mixed the first pillar 140 and the second pillar 150. Furthermore, the first external chamfer 142 and the corresponding second internal chamfer 242 are respectively defined on the first pillar 140 and the corresponding first slot 240, and the first pillar 140 is therefore not able to plug into the first slot 240 along an incorrect direction.

Although the present disclosure has been described with reference to the foregoing preferred embodiment, it will be understood that the disclosure is not limited to the details thereof. Various equivalent variations and modifications can still occur to those skilled in this art in view of the teachings of the present disclosure. Thus, all such variations and equivalent modifications are also embraced within the scope of the present disclosure as defined in the appended claims.

What is claimed is:

1. A power plug, comprising:
an insulation main body having a main body top surface, a first pillar and a second pillar being protruded from the main body top surface, the first pillar and the second pillar being arranged at interval, a first channel being defined on the first pillar along a longitudinal direction of the first pillar, a plurality of second channels being defined on the second pillar along a longitudinal direction of the first pillar, and the first channel and the second channels being arranged in a row;
a first plug terminal inserted in the first channel; and
a plurality of second plug terminals, each second plug terminal being inserted in one of the second channel.

2. The power plug according to claim 1, wherein a plurality of main body lateral surfaces surrounding the main body top surface are formed on the insulation main body, and a hook is provided on one of the main body lateral surfaces.

3. The power plug according to claim 1, wherein a first external chamfer is arranged at a corner of the first pillar.

4. The power plug according to claim 1, wherein a second external chamfer is arranged at a corner of the second pillar.

5. A power receptacle for coupling with the power plug according to claim 1, the power receptacle comprising:
an insulation base having a base top surface, a first slot for sheathing the first pillar and a second slot for sheathing the second pillar being defined on the base top surface, and the first slot and the second slot being arranged at interval;
a first receptacle terminal for coupling with the first plug terminal, and a first terminal being inserted in the first slot; and
a plurality of second receptacle terminals respectively inserted in each second slot for coupling with the second plug terminals, the second plug terminals being arranged at interval and parallel with each other, and the first receptacle terminal and the second receptacle terminals being arranged in a row.

6. The power receptacle according to claim 5, wherein a plurality of base lateral surfaces surrounding the base top surface are formed on the insulation base, and a latch is provided on the base lateral surfaces.

7. The power receptacle according to claim 5, wherein each first receptacle terminal is extended to protrude a bottom of the corresponding first slot.

8. The power receptacle according to claim 5, wherein each second receptacle terminal is extended to protrude a bottom of the corresponding second slot.

9. The receptacle according to claim 5, wherein a first internal chamfer is arranged at a corner of the first slot.
